(19) United States
(12) Patent Application Publication
(10) Pub. No.: US 2002/0174063 A1
(43) Pub. Date: Nov. 21, 2002

(54) Automated donation process and system therefor

(75) Inventor: Deirdre Major, New York, NY (US)

Correspondence Address: WILLIAM COLLARD, COLLARD & ROE, P.C., 1077 NORTHERN BOULEVARD, ROSLYN, NY, 11576, US

(73) Assignee: CASTAGNA REALTY CO., INC.

(21) Appl. No.: 09/860,001

(22) Filed: May 17, 2001

(51) Int. Cl. G06F 17/60

(52) U.S. Cl. 705/39; 705/40; 705/14

(57) ABSTRACT

A system and a process for automatically tracking and allocating charitable contributions related to a purchase in a store. Essentially, this invention may include one of the following systems and processes: a system and a process for automating the tracking and allocation of a charitable contribution; a system and a process for tracking charitable donations related to purchases; a system and process for calculating charitable donations; and a system and process for allocating or distributing these charitable donations to a set of participating charities once these charitable donations have been calculated. Essentially, the system associated with this process is in the form of either at least one in house server connected to a computer network; at least two servers connected to a computer network wherein at least a first server primarily tracks purchase information, while at least a second server connected to the first server decodes this purchase information and tracks charitable contributions; or three or more servers wherein there is included the first two servers and at least one additional server to compile and save the information stored on the first two servers.

### BACKGROUND OF THE INVENTION

Field of the Invention

The invention relates to a system and a method for allocating charitable contributions based upon purchases in a store. More particularly, this invention relates to a system and a method for tracking purchases with buyers to provide charitable contributions to charities.

### SUMMARY OF THE INVENTION

The invention relates to a system and a process for automatically tracking and allocating charitable contributions related to a purchase or purchases in a store. This invention may include a system and a process for automating the tracking and allocation of a charitable contribution; a system and a process for tracking charitable donations related to purchases; at least one system and process for calculating charitable donations; and a system and process for allocating or distributing these charitable donations to a set of participating charities once these charitable donations have been calculated.

Essentially, the system associated with this process is in the form of one of three different network structures. In a first network structure, there is at least one in house server connected to a computer network wherein this house server is sufficient to perform the processes described above. In the second network structure there are at least two servers connected to a computer network wherein at least a first server primarily tracks purchase information, while at least a second server connected to the first server decodes this purchase information and tracks charitable contributions. The third network structure is similar to the second network structure, however there are three or more servers wherein there is included the first two servers and at least one additional server to compile and save the information stored on the first two servers.

The system and process to automate the tracking and allocation of donations include a series of different systems to register a user such as a purchaser, a charity, or a store. One way to register a user, would be through filling out a paper form and either mailing or faxing this form into a system host. Another way to register a user, would be via the telephone whereby the user, charity or store would convey the information required for registration. Finally, a third way to register a user, would be to provide web pages or any similar type interface designed to register at least one user. From the information received from these users, each purchaser can then automatically make donations to his or her selected charity by using this system. With this design, information can be sent from one of the users on a remote terminal such as a telephone, a remote computer terminal or a point of purchase to one of the servers in the network. All of this information is then stored in a series of tables in at least one database in at least one of the servers on the network.

At least one of these servers has a processor that when coupled with a computer program is used to perform a series of functions designed to calculate the appropriate donation for one or more of the registered charities. Essentially, the processor(s) on this computer network performing this process are known as a system host. Once the donation has been calculated, the system host stores this information in a table in the database and then sends a statement regarding the donation amount to the tenant to pay and also a statement to these charities.

In addition, there can also be a system and a process for tracking charitable donations arising out of, and related to at least one purchase by a user. This system and process substantially includes the system and process for tracking and allocating charitable donations but also includes additional features. For example the system includes an identification card that is used to track the purchases made by users in a particular store. Each user is assigned an identification card which contains a tracking number or any other type identification means. The identification card is then used to match any purchases made by the user with that user. However, at all times throughout this system and process, the identity of the user is safeguarded to keep confidentiality between the system host and the user making purchases.

This system and process is designed to work with a particular set of participating stores. In this case, the system and process includes registering a series of participating stores along with the registration of at least one purchaser and at least one charity. Each store then receives at least one identification card reader that is designed to read the identification card held by the purchaser. The identification card reader is then connected either directly, or through a remote computer to the computer network.

This identification card reader and identification card system can be either included with a credit card system or it can be used as a stand alone device. This card reader can either read both cards or a combined card that includes both a credit card and a identification card.

With the stand alone version, purchasers who are participants in the system can decide whether to purchase using cash, a check, a debit card, a credit card or any other type of payment. If a purchaser decides to purchase an item using cash, a store owner or point of purchase attendant would enter the amount of the purchase into the identification card reader and then take the purchaser's identification card and run the card through the reader. The amount of the purchase that was entered would then be matched with the purchaser, by matching this sale with the purchaser's identification number. The information received by the identification card reader is then sent through the communication network to at least one of the servers where this information is then stored into database tables. The server then calculates the amount of the charitable contribution as a portion of the sale and then based upon the information entered by the purchaser during the enrollment process, the server allocates this charitable amount to the proper charities.

If the purchaser wanted to purchase items using a credit card, the store owner or point of purchase attendant would first ring up the sale using the purchaser's credit card. While the purchaser's credit card company is processing this purchase, the store owner or point of purchase attendant would then enter the amount of the purchase into the identification card reader, and then take the purchaser's identification card. The purchaser's identification number would be entered into the identification card reader either by sliding the identification card through the reader or pressing number keys on the identification card reader. The identification card displays the identification number for the purchaser on the front or back face of the identification card.

In addition, a credit/debit card could be assigned a separate or tracking identification number for tracking purchases by purchasers in participating stores. With this design, a combination card reader is used to read a combination credit/debit and identification card. Thus, a separate identification card is not necessary to fulfill this type of transaction. Instead, the purchaser is issued a special credit card that contains this tracking number embedded in its magnetic strip and shown on its face. Once the credit card is used for a particular purchase, the credit card reader also reads the tracking number to match the purchase with the purchaser. With this design, this tracking number can either be the same number as the purchaser's credit card number or a separate tracking number to track purchases associated with that purchaser.

There is also at least one system and process for calculating charitable contributions associated with the system and process for automating the tracking and allocation of a charitable contribution. Essentially, when the user enrolls in this charitable program, the user can select one of three main programs to allocate his or her charitable contributions either with the user's purchases, or with a predetermined amount for donation. The first program is designed to distribute the user's donation evenly among the charities that the user selects. With this design, the user selects from a checklist the charities that the user wants to send his or her contribution. Once these charities have been selected, all money designated for the user's charitable contribution will be split evenly among these charities and then distributed to these charities.

A second program for calculating charitable contributions allows the user to apportion different percentages of the user's charitable contribution to different charities. Therefore, the user can not only select the charities where the user wants the donation sent, but also weight the donation so that this donation is distributed unevenly among the different charities. For example, if the user selects four charities, the user can weight the charities based upon the user's preference such as 60% of the contribution for the first charity, 20% of the contribution to the second charity, 15% of the contribution to the third charity and 5% of the contribution to the fourth charity. Thus, with this program, a user can weight his or her contribution to his or her preferred charity.

A third program involves setting an order for donation and a donation cap on the donation amount to each charity. For example, if the user selects four charities, the user can select to have the first $50 of the charitable contribution go to the first charity, the next $100 of the charitable contribution go to the second charity, the next $25 of the charitable contribution go to the third charity, and the remaining amount to go to the fourth charity. Thus, with this program, the user can set a preference for particular selected charities over the remaining charities while insuring that a minimum amount is distributed to the preferred charities.

There is also a system and process for distributing this charitable contribution once it has been allocated by each of the users. Essentially, all of the charitable contributions by each user are stored in a first main table detailing the purchases made by each user and the charitable donation resulting from this purchase. The charitable donations are tallied up for each user and then the total amount of charitable donations for each user is stored in a second table. Next, based upon the user's selected program, the user's formula for donations is applied to the total amount of charitable donations associated with that user.

Once this formula has been applied, the system host determines the amount of charitable donations that are to be given to each charity and forms another table indicating the charitable donations that are due to each charity. In addition, in using this formula, another table is created for each user showing that user the amount that is donated to each charity that was selected by that user.

Thus, with this design, a user enrolling in this program can distribute charitable contributions to his or her favorite charity through the result of a purchase at a participating store.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings wherein similar reference characters denote similar elements throughout the several views:

FIG. 1 shows a schematic representation of a computer network which is the system for running a series of processes relating to the invention;

FIG. 2, shows a schematic representation of a three server network for conducting the process;

FIG. 3A is a flow chart showing the process for registering a user;

FIG. 3B is a representation of a screen for registering a user;

FIG. 3C is a screen shot of a screen for selecting a charity or multiple charities;

FIG. 3D is a screen shot representing the selection screen for selecting a type of donation system;

FIG. 3E is a screen shot for the registered screen for registering a user under the standard donation system;

FIG. 3F is a screen shot for the registered screen for a user under the weighted donation system;

FIG. 3G is a screen shot for the registered screen for a user under the capped donation system;

FIG. 3H is a representation of a screen for adding contact information;

FIG. 3I shows a copy of a front face of an identification card;

FIG. 3J represents a copy of a back face of the identification card;

FIG. 4 is a screen shot for the selection screen for registering either a charity or a store;

FIG. 5A is a flow chart representing the process for registering a charity;

FIG. 5B is a screen shot for a screen for registering a charity;

FIG. 5C is a screen shot for a screen for a registered charity;

FIG. 6A is a flow chart representing a process for registering a store;

FIG. 6B is a screen shot for a screen for registering a store;

FIG. 6C is a screen shot for a registration screen for a registered store;

FIG. 7 is a flow chart for the process for tracking a purchase and allocating a portion of this purchase to a charity;

FIG. 8 is a flow chart for a second type of process associated with the process in FIG. 7;

FIG. 9A shows a table listing the unique charity shoppers by revenue;

FIG. 9B shows a table listing unique customer profiles by card;

FIG. 9C shows a table listing an individual customer profile by card;

FIG. 9D shows a table listing the individual total purchase amount;

FIG. 10A shows a table listing charity results by alphabetical sequence;

FIG. 10B shows a table listing charity results by revenue;

FIG. 11C shows a table listing charity comparison by revenue for the last three years;

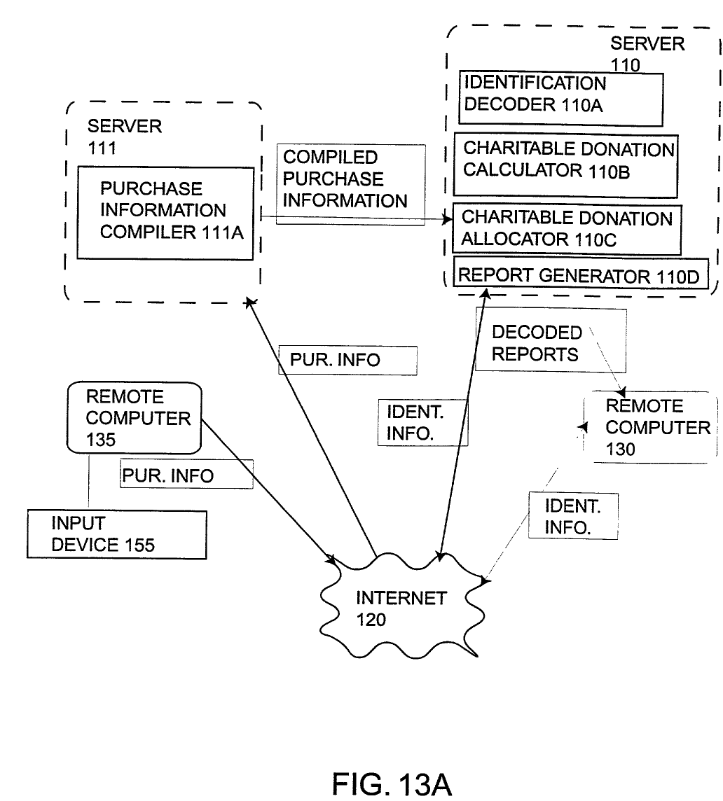

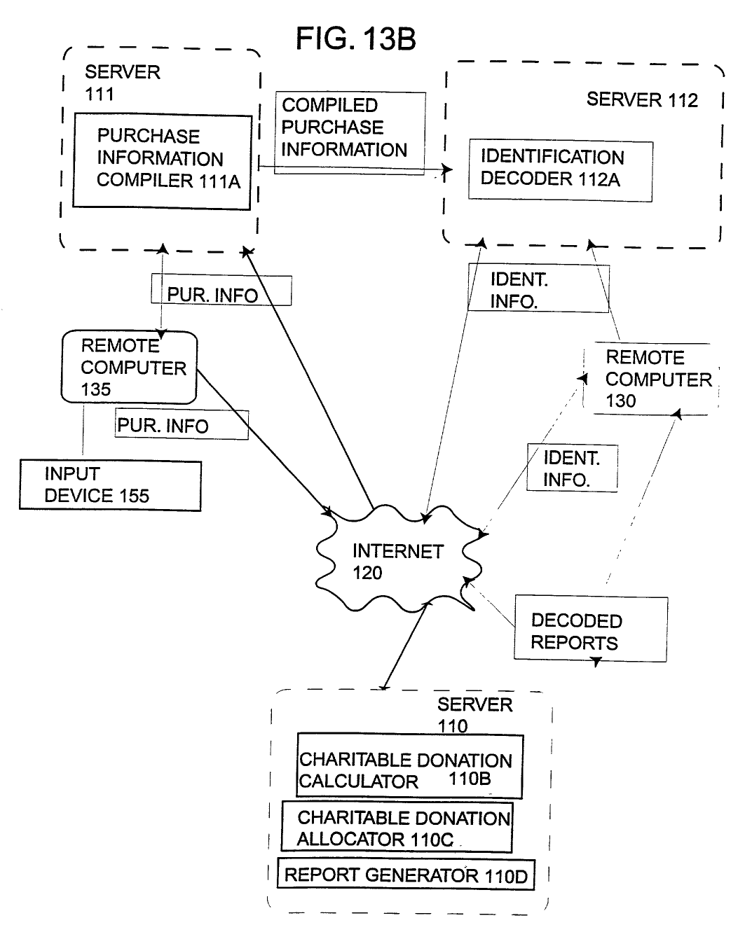

FIG. 10D shows a table listing the charity results by the store;

FIG. 11A shows a table listing the charity results by store with donation only;

FIG. 11B shows a table listing a charity shopper list by charity;

FIG. 11C shows a table listing a price range report;

FIG. 12A shows a table listing the store results;

FIG. 12B shows a table listing the store results by revenue;

FIG. 12C shows a table listing store detail report by alphabetical sequence;

FIG. 13A shows a schematic representation of a two server network showing the flow of information across the network; and

FIG. 13B shows a schematic representation of the three server network showing the flow of information across the network.

### DETAILED DESCRIPTION OF THE PREFERRED EMBODIMENT

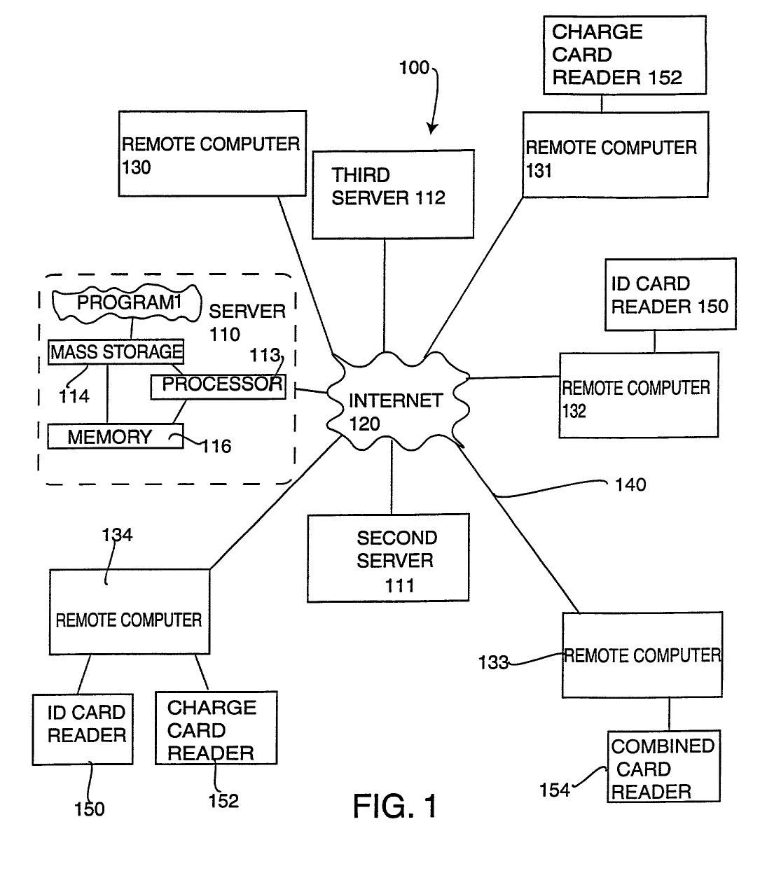

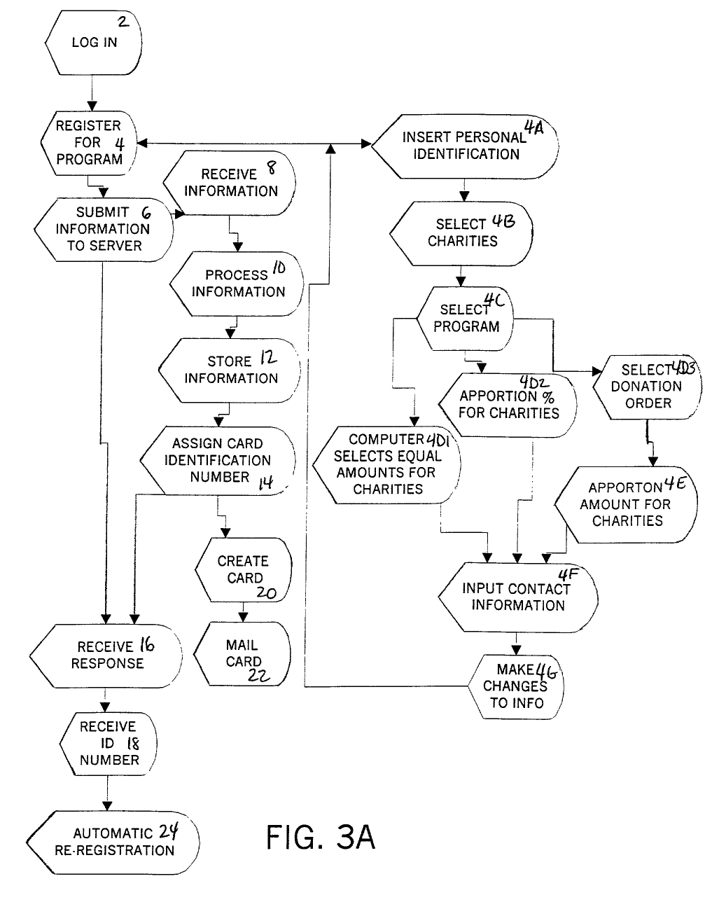

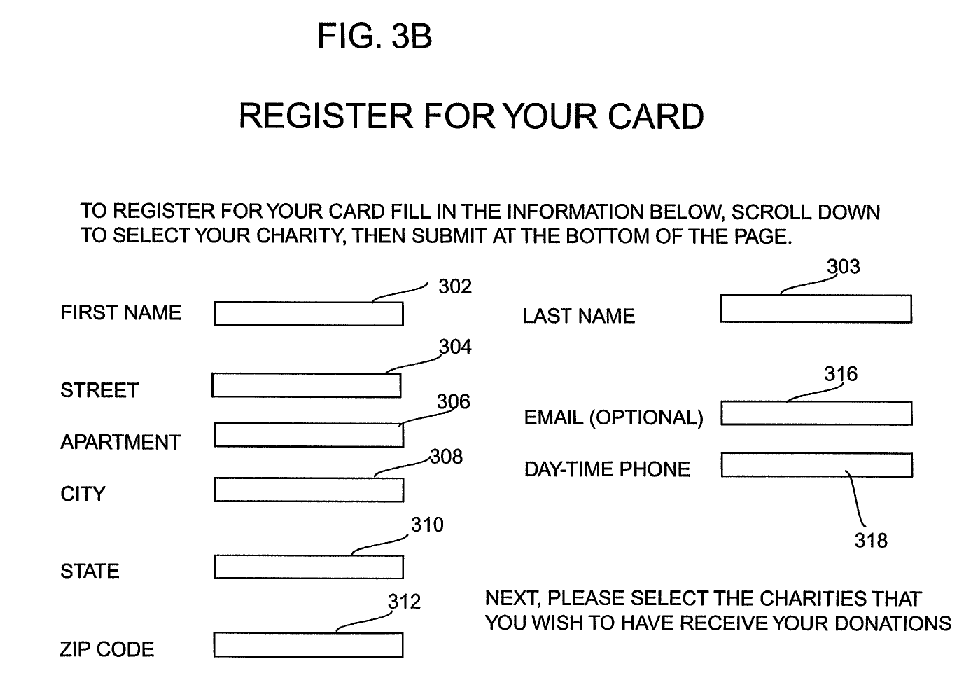

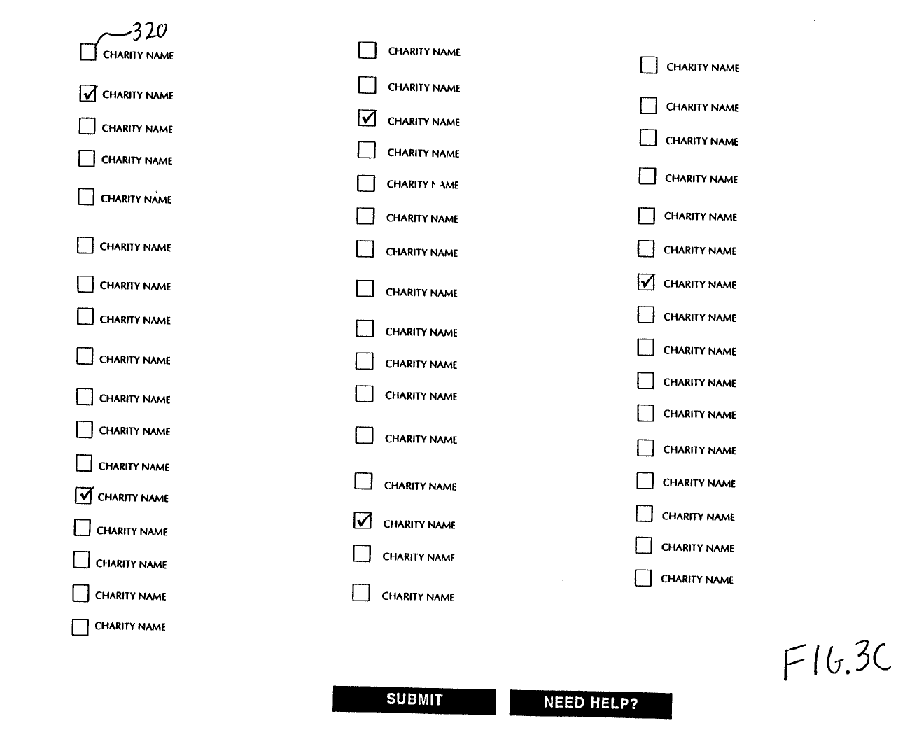

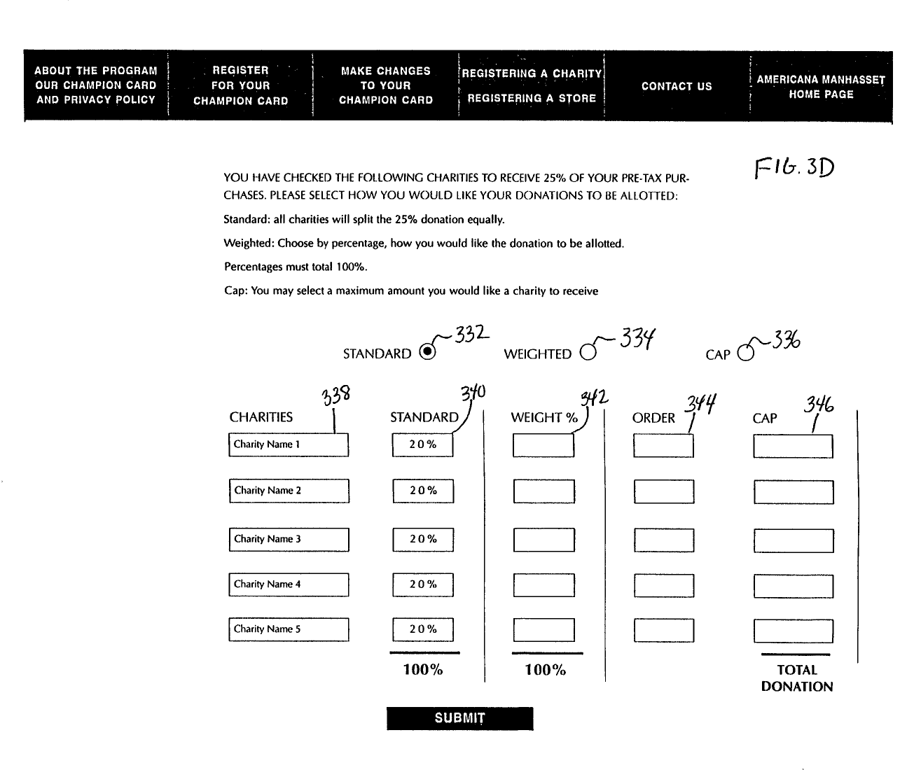

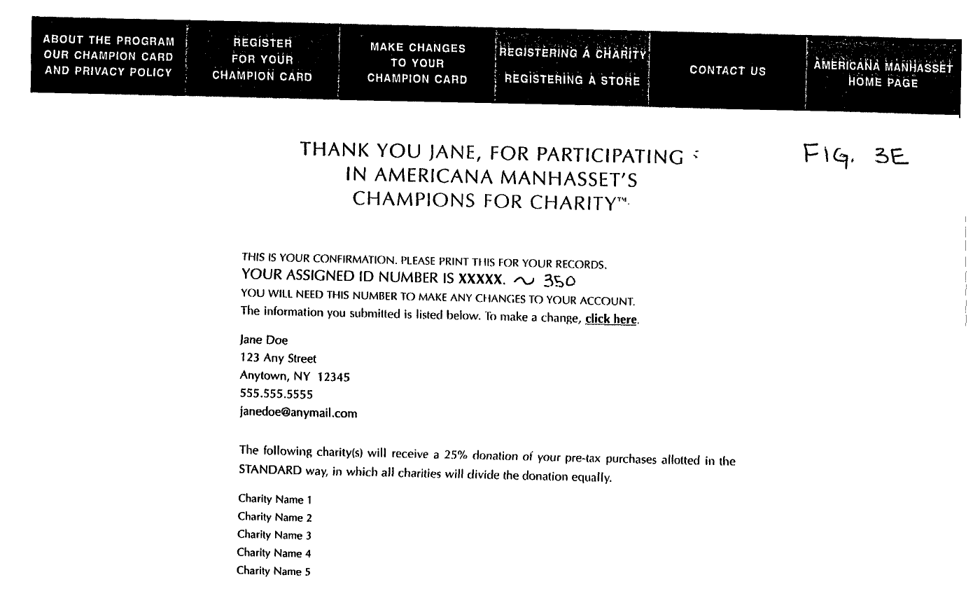

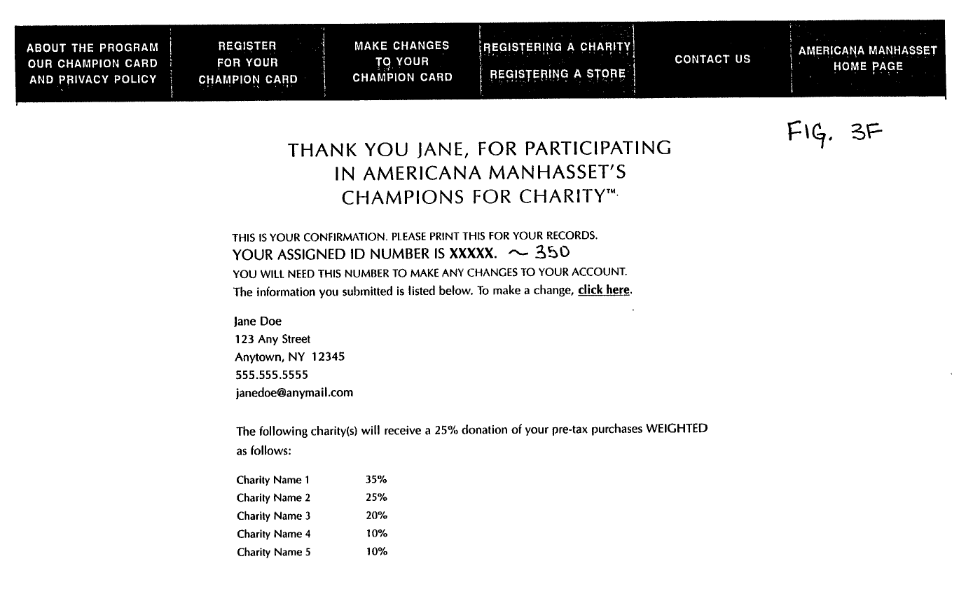

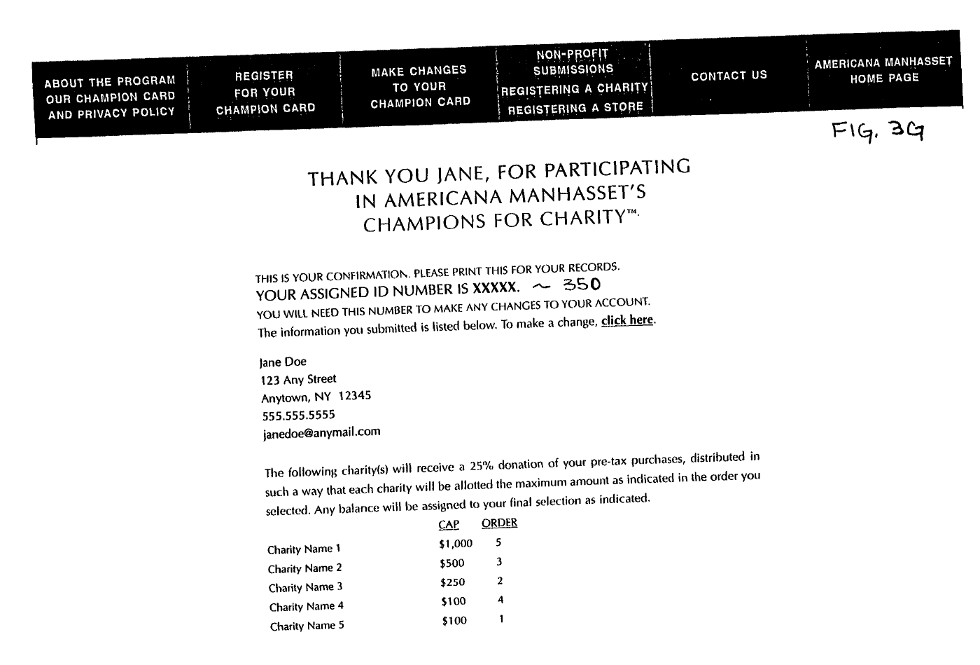

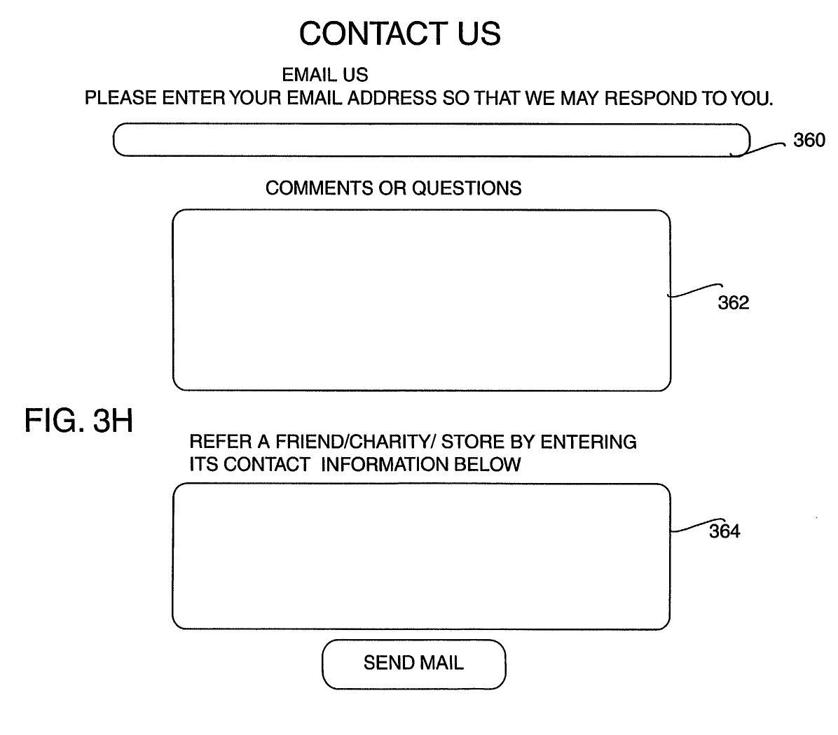

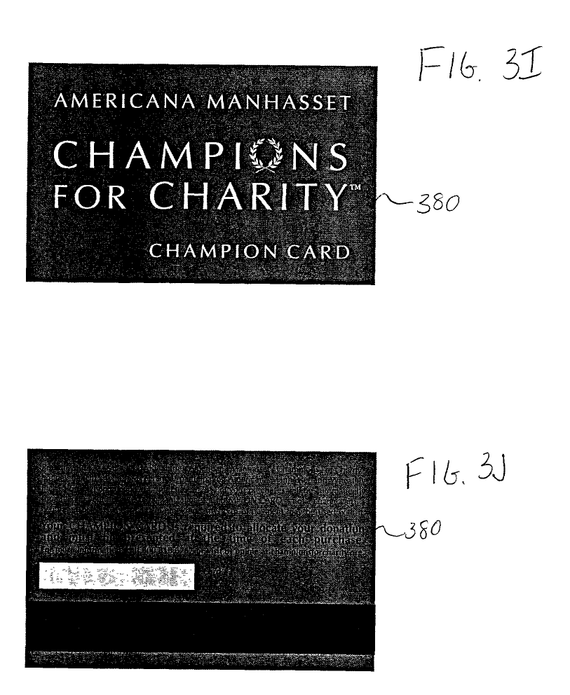

FIG. 1 refers to a computer network 100 that includes the internet or an intranet, which is a closed computer network. In this computer network is a server 110 that comprises a processor 113, a mass storage 114 and a memory 116. Processor 113 could be formed from a processor manufactured by the Intel Corporation or Advanced Micro Devices Corporation or any other type processor manufacturer. Processor 113 runs a program that sets forth a series of steps shown in FIGS. 3A through 5A, 6A, 7 and 8. The program provides instructions to processor 113 to perform a series of sequential or non-sequential steps. Information generated or associated with this program can then be stored on mass storage 114, and then loaded into memory 116. Both processor 113, mass storage 114 and memory 116 are all interconnected so that all three components run together on server 110.

Program 1 can be either stored in mass storage 114 or imported to server 110 from another computer network 100. Server 110 is connected to a second server 111, and general computer network 120 which also connects to a series of remote computers 130-134. Computer network 100 could be either the internet or the intranet system which includes either additional servers or additional remote computers. In this case, server 110 differs from remote computers 130-134 in that server 110 acts as a central store for communication between remote computers. Computer 130-134 can either be connected to computer network 100 on a client server basis wherein remote computers 130-134 are a client or on a peer to peer network wherein each remote computer is interconnected with each other remote computer.

An identification card reader 150 a charge card reader 152 and a combination card reader 154 are can be connected to network 100. For example charge card reader 152 can either be connected directly to network 100 or through remote computers 131 and 134. In addition ID card reader 150 can be connected to remote computers 132 and 134 while combined card reader 154 which is a combination of ID card reader 150 and charge card reader 152 can be connected to remote computer 133. However, for purchases to be recorded into the system, either ID card reader 150 or combination reader 154 must be present to read the identification number of a user enrolled in the program.

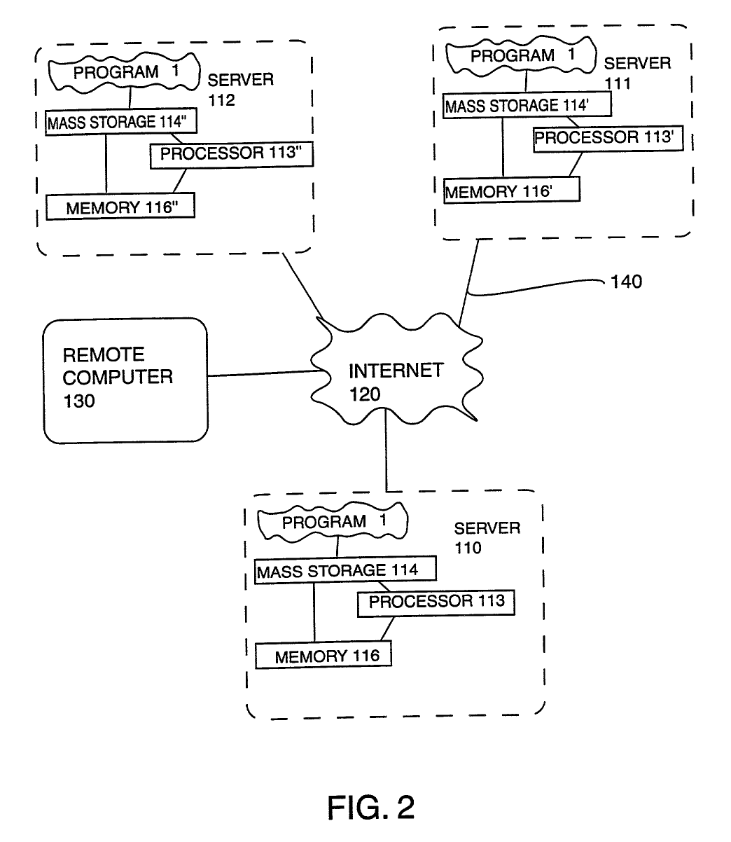

As shown in both FIGS. 1 and 2, a series of additional servers could also be provided on network 100. Essentially this program, and the information associated with this program could be segmented across multiple servers to insure the reliability of the system, increase security within the system, and also to assure users of a private transaction. For example, as shown in FIG. 1, information could be distributed equally across all three servers 110, 111, and 112. However, if the system host wanted to insure security or insure the privacy associated with these transactions, this process could be distributed in different parts across all three servers.

For example, a second server 111 and a third server 112 could be provided to handle some of the processing work associated with program 1. In another embodiment, second server 111 would read the purchase information, and then forward this information to third server 112 to match this purchase information with identification information associated with users, charities and store owners. Next this information is then sent onto server 110 for processing and storage. With these additional servers, it is possible to conduct purchase based transactions using multiple parties. Thus, in this secure system, all registration information including all personal information would reside on server 112 separate from all transaction or purchase information which is received through server 111.

In this distributed environment, program 1 could be stored in different parts in mass storage 114, 114′ or 114″ on servers 110, 111 or 112 or uploaded into these servers from another computer in communication with these servers. Program 1 would then load into memory 116, 116′ and 116″ on servers 110, 111 and 112 respectively. From memory 116, 116′ and 116″, program 1 would then communicate with processors 113, 113′ and 113″, such that these processors would perform a series of steps shown in FIGS. 3A, 5A, 6A, 7 and 8.

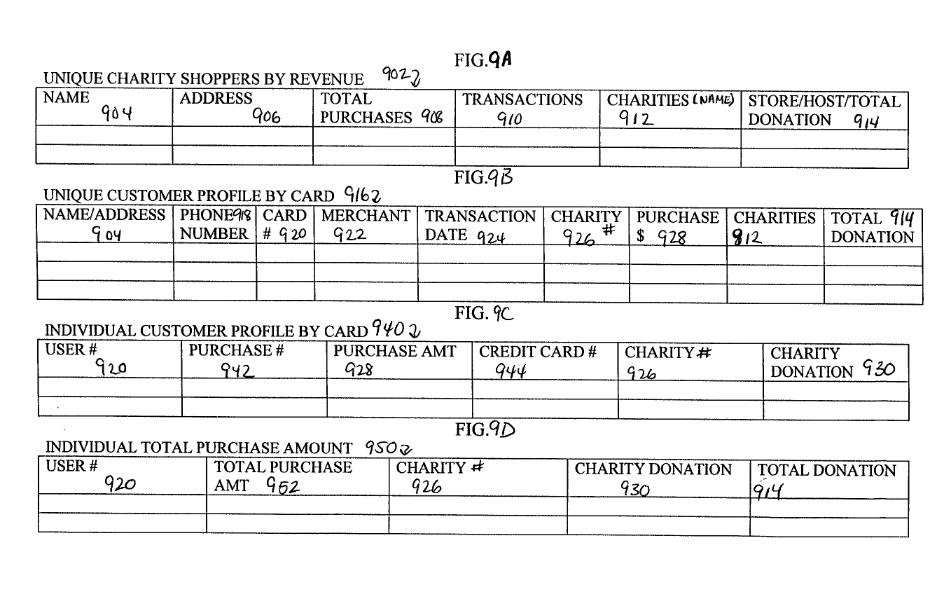

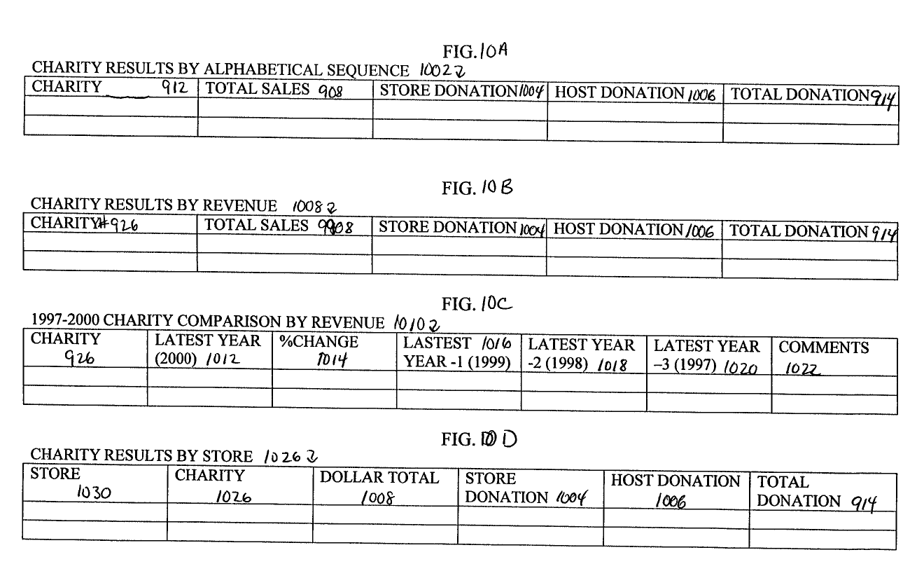

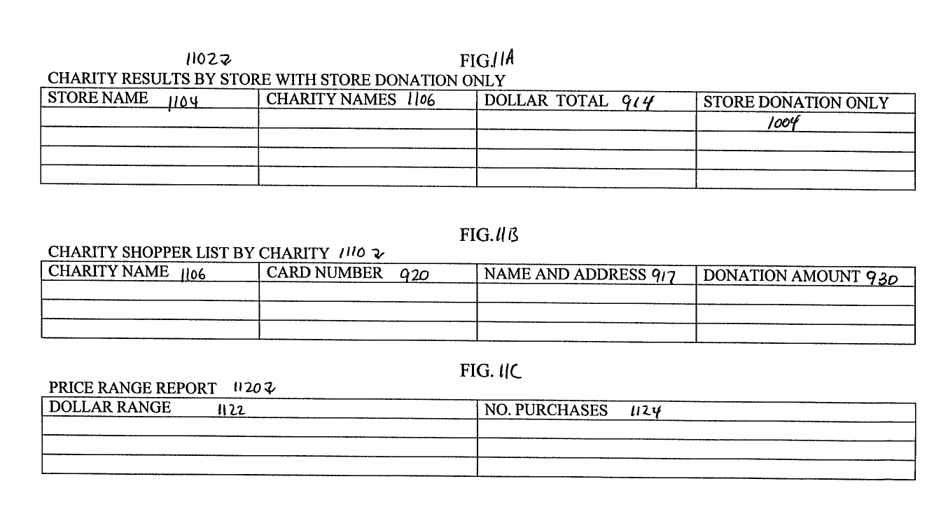

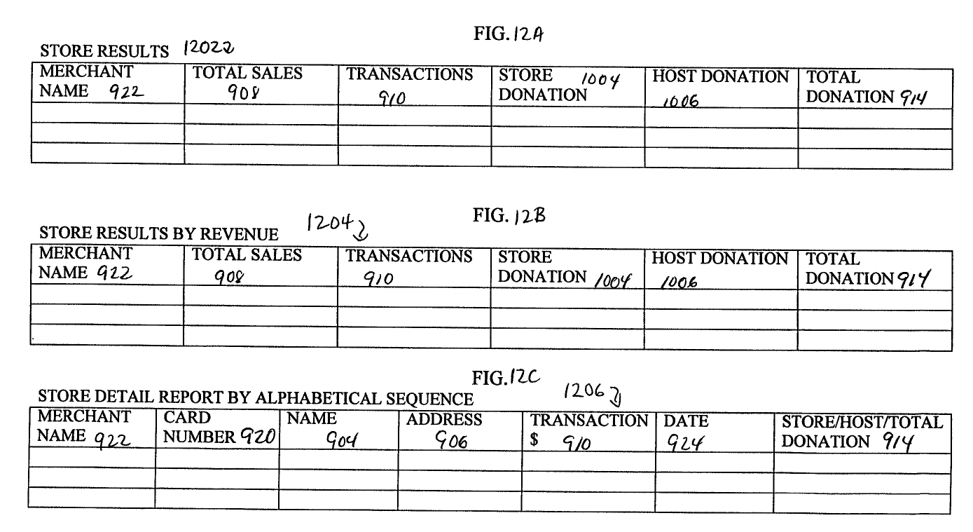

In addition, there is also a series of tables shown in FIGS. 9A-12C wherein these tables can either be stored in mass storage 114, 114′ or 114″ or imported from another computer on computer network 100. These tables contain a set of information or data that is either generated by program 1 or works along with program 1 to perform either a series of functions or provide a series of solutions. The data in these tables is loaded into memory 116, 116′ or 116″ and is then manipulated or altered by processor 113, 113′ or 113″ to either create new sets of data tables or change the values of the data in the original sets of tables or simply remain the same data in those tables.

As shown in FIG. 3A, users can register either via a paper form or by using website having a series of webpages shown in FIGS. 3B-3H on a remote computer 130 on a computer network.

Essentially, this process is a cooperative agreement between the user, store owners, and charities to provide charitable revenue based on purchases within a series of stores. Accordingly, in a first embodiment, this process results in a donation of approximately 25% of all purchases to user selected charities when a user purchases in a participating store. This process can exist over a set period of time such as an annual occurring event such as a week in December before the holiday season.

To register for the program, in step 2 a user using remote computer 130 logs into the system by moving to a website for hosting the registration process. This website could be hosted by servers 110, 111, or 112, or any other server on computer network 100. Next, in step 4, the user registers for an identification card 380 shown in FIGS. 3I and 3J, which is associated with this charitable process. This identification card is designed to record the amount of the purchase, the person making the purchase and the store location of that purchase. In that way, when a user using the card makes a purchase in a participating store, the program will record the store location, the amount of the purchase and the user purchasing it so that 25% of this purchase will go to the charity selected by the user.

During this registration stage in step 4, as shown in FIG. 3A, the user inputs his personal identification into a webpage shown in FIG. 3B. In step 4A, the user enters information into the following fields: first name 302, last name 303, street address 304, apartment 306, city 308, state 310, zip code 312, email address 316, and daytime phone number 318.

Next, in step 4B shown in FIG. 3C, the user selects one or more of a series of charities by checking one or more of a series of boxes 320 disposed adjacent to each charity. In a first embodiment, the charitable donations are apportioned equally to all of the charities selected. However, in an alternative embodiment, as shown in FIG. 3D, the user can select in step 4C one of three different donation programs. For example, in step 4D1, the user can select to either donate equal amounts of a charitable contribution by selecting box 332, or in step 4D2 the user can select to donate a particular percent of a charitable contribution by selecting box 334, or in step 4D3 the user can donate a particular amount of the charitable contribution to different charities on a cap basis by selecting box 336. The charities selected on the webpage shown in FIG. 3C are also entered into boxes 338.

If the user selected the standard donation allocation as in step 4D1, then the standard amount is calculated by the system host by dividing 100 by the number of charities selected. This number is then entered into boxes 340. However, if the user selected a weighted donation system as in step 4D2, then this information would be manually entered into boxes 342 with the total amount for each percentage donation adding up to 100%.

If the user selected the cap system as in step 4D3 then the user would enter the donation order for these charities and then input the cap for these charities in step 4E and in box 346. Each of these three different options are different embodiments of the present invention.

Next, in step 4f, the user enters contact information so that the user can make comments, ask questions or refer other users such as purchasers, charities or stores. This step is through entering information into a web screen shown in FIG. 3H. Next, in step 4G, the user can make changes to the information just entered by proceeding back to the web page shown in FIG. 3B or the user can submit this information in step 6.

Once this information has been submitted to either server 110, 111, or 112 in step 6, that server receives the information in step 8, and processes this information in step 10 by authenticating this information and analyzing whether this information is correct. If the information entered is correct, then in step 12, the server stores this information into a series of tables which are stored in mass storage devices 114, 114′ and 114″.

Next, in step 14, the system host assigns an identification number to that user and then sends a registration response to the user. In step 16, the user receives this response in the form of one of three possible registration screens shown by FIGS. 3E, 3F and 3G. FIG. 3E representing the registration screen after the user selected the standard method for donation, FIG. 3F representing the weighted method for donation and FIG. 3G representing the capped method for donation. With this response in step 18, the user receives an identification number 350 which allows the system to track each user and to separate the user's personal profile from the user's purchasing transactions.

During this period, in step 20, the system host orders the creation of card 380 shown in FIGS. 3I and 3J and then this card is mailed to the user in step 22. This user can then be automatically re-registered in step 24. Each user will be automatically reregistered on an annual basis unless this user specifically requests to not re-register.

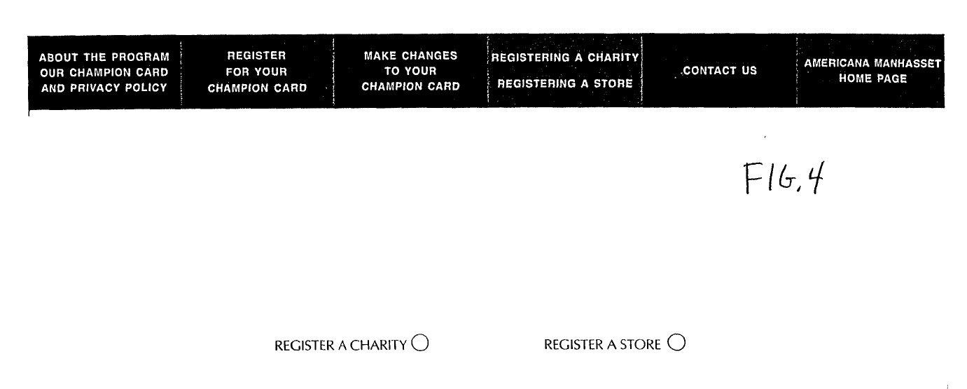

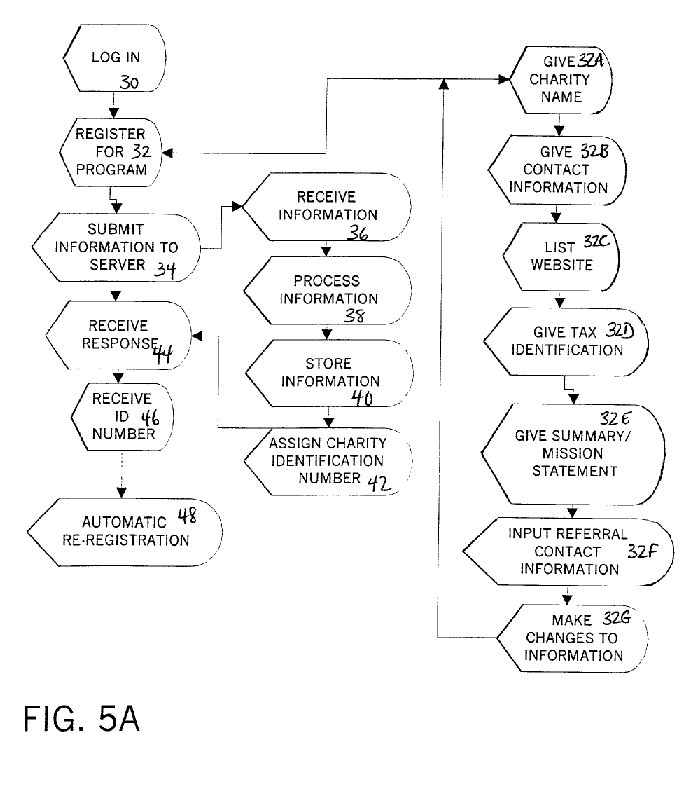

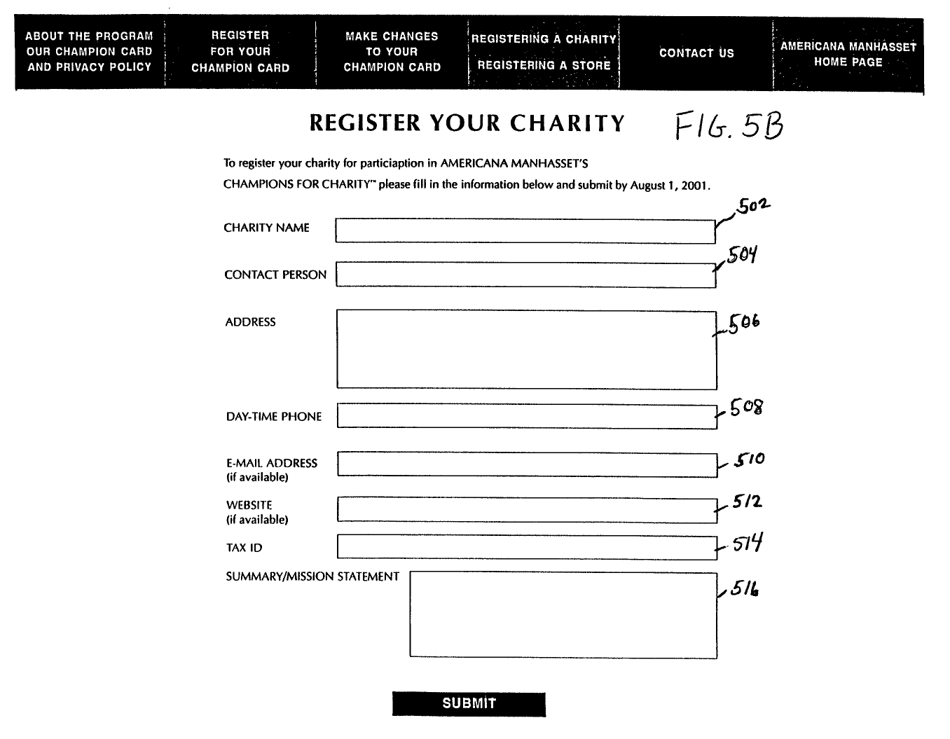

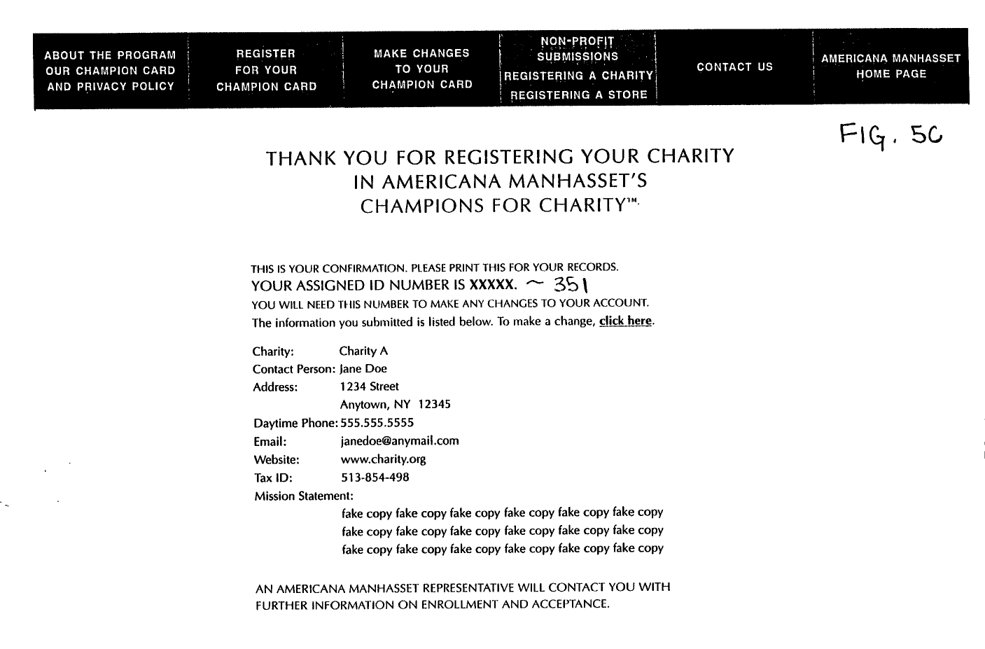

FIG. 4 shows a selection screen that allows a user such as a charity or a store owner to register a charity or a store. If the user is a charity, then the system host would proceed with the process for registering a charity shown in FIG. 5A.

FIG. 5A shows the process for registering a charity, wherein a user in step 30 logs into the system and next, in step 32, registers for the program. The user registers for the program by entering information about the charity into a web page shown in FIG. 5B. This entry process occurs during a series of steps with information being entered into the following fields: in step 32a the user enters the charity name 502, in step 32B the user enters the contact information including the name of the contact person 504, the address 506, the day-time phone number 508, and e-mail address 510, next in step 32C the user enters the website 512, in step 32D the user enters tax id 514, and in step 32E a summary mission statement 516. This summary mission statement would include the goals of the charity so that it describes the purpose of this charity to any user interested in donating to that charity.

Once this information has been entered into the webpage, in step 32F, the user can enter in any referral or contact information into a web page such as that shown in FIG. 3H. Next, in step 32G the user can make changes by going back to step 32A.

Once this information has been entered into the webpage shown in FIG. 5B, it is submitted to a server in step 34. In step 36, the server receives this information and then processes this information in step 38 by placing this information into a series of tables. Next, in step 40, this information is then stored in storage device 114, 114′ or 114″.

The system host next, in step 42 creates a charity identification number to identify the charity in the stored tables. This charity identification number is also stored with this information in the tables.

Next, in step 44, the user receives a response in the form of a registration screen shown in FIG. 5C. Included on this registration screen is an identification number 351 which the user receives in step 46. This identification number 351 allows the system host to identify and track donations to the charity while keeping the charities identification secret to other users. Finally, in step 48 the system host will automatically re-register the user for annual membership unless the user presents a request to not be included.

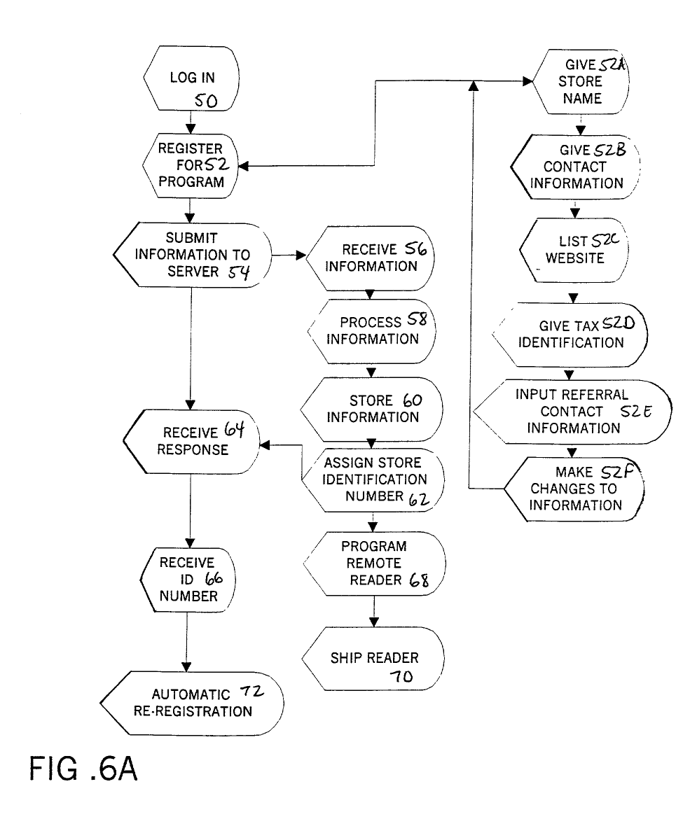

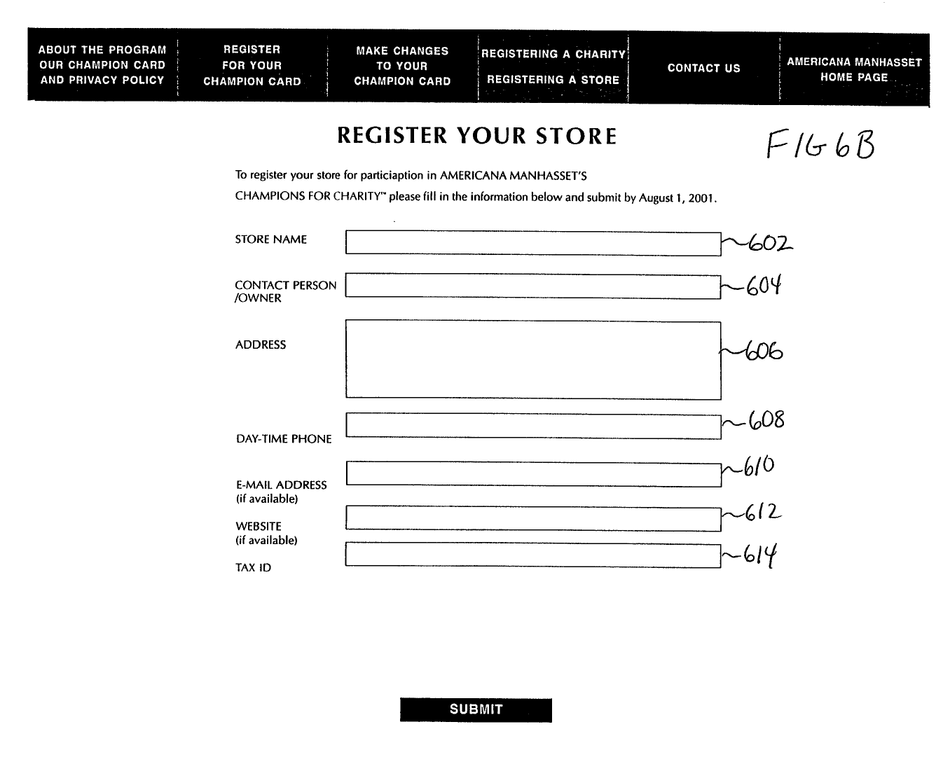

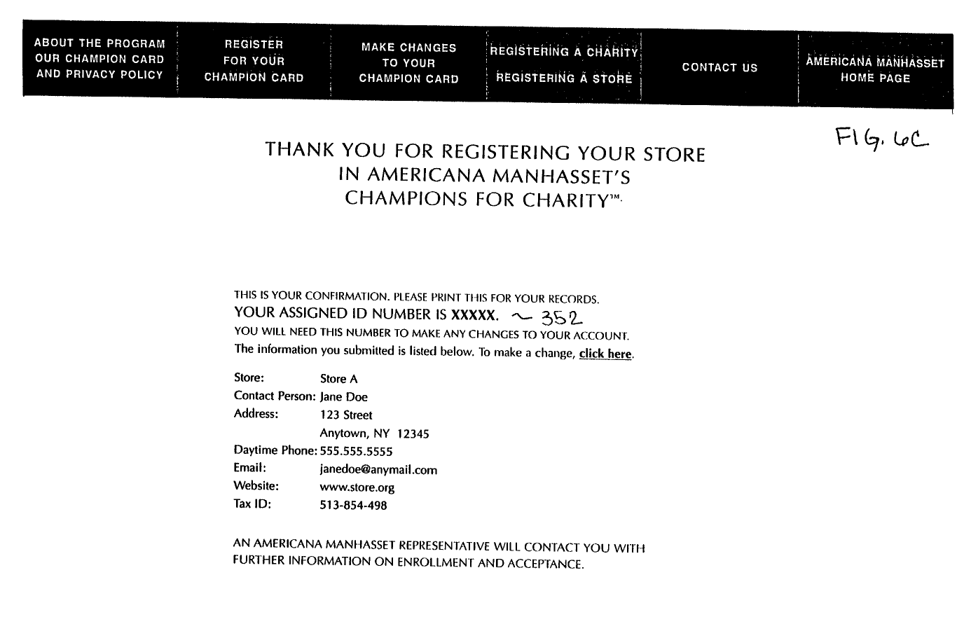

FIG. 6A shows the process for registering a store. In step 50 a user logs into a server hosting a website shown in FIG. 6B. From this website, the user registers for the program in step 52 by entering information about the charity over a series of steps into the following fields: in step 52A the user enters the store name in field 602, in step 52B the contact person in field 604, the address in field 606, the day-time phone in field 608, and the email address in field 610, in step 52C the user enters the store's website in field 612, while in step 52D the user enters the tax identification number in field 614. Next, the user enters the referral contact information in step 52E and then the user can enter any change to this information in step 52F by proceeding back to step 52A.

Next, in step 54, the user submits this information to the system host or server whereby in step 56, the system host receives this information and then processes this information in step 58 by creating a series of tables. This information is next stored in the server in step 60, while in step 62 the system host next assigns a store identification number 352. The user then receives a response 64 in the form of a webpage shown in FIG. 6C. In step 66, identification number 352 is then presented to the user on this webpage. During this period of time, in step 68 a remote reader is programmed and then in step 70 this reader is shipped. The user/store owner can then be automatically re-registered for this program in step 72.

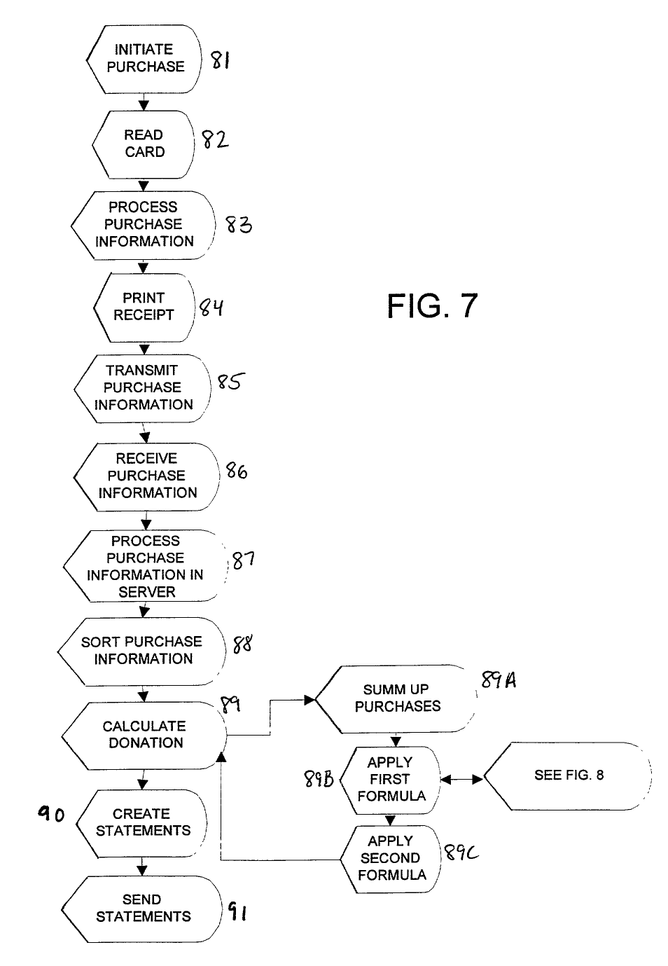

FIG. 7 shows the process for making a purchase and allocating a charitable contribution from that purchase. In step 81, a user initiates a purchase in a store whereby the user brings the items for purchase to a counter or point of purchase. At this point, in step 82, the attendant at this counter or point of purchase would process this purchase and run card 380 through either the ID card reader 150, or the combined card reader 154. This step could occur through either remote computer 132, 133 or 134 (See FIG. 1). For example if the user had a card 380 that was simply a charitable donation identification card then the attendant would only run this card through ID card reader 150 on remote computers 132 or 134. Or, if the user had a combination card but the user was purchasing the item(s) through a non credit card means such as cash, check, money order, coupon etc., then the attendant would only use identification card reader 150 on remote computers 132 or 134.

However, if the user had a combination card, which had an identification number for both credit or debit card use and also an identification or tracking number 351, then the attendant could ring up the sale using the combination card in combination with combined card reader 154 on remote computer 133.

In step 83 the attendant would process this purchase information by verifying whether the method of payment and/or the identification card was valid. If the method of payment or the identification card was invalid then the purchase process would not proceed. However, if both the method of payment and the identification card were valid, then in step 84 the attendant would print a receipt for the purchase. In step 85, this purchase information would then be sent to the system host. In step 86, the system host would receive this purchase information and then in step 87, process this purchase information by reading, translating, organizing and distributing this information into a series of one or more tables shown in FIGS. 9A to 12C In step 88, the system host would sort this purchase information to create a preliminary version of the tables shown in FIGS. 9A-12C. From these preliminary tables, in step 89, the system host would calculate the donation for each user by one of two methods. In a first method, the system host would proceed to step 89A whereby all of the purchases for each user would be summed up. Next, in step 89B, a first formula would be applied to the purchases. This first formula would be:

(Purchase Amount)×(Donation Rate)=Charitable Donation (1)

While the purchase amounts may vary depending on what each user may purchase, the donation rate could be preset at a standard donation rate such as 25% of each purchase. For example, if a user purchased a $100 pair of shoes, and the donation rate was 25% or (0.25) then the total charitable contribution from this purchase would be $25.

Next, in step 89C a second formula is applied. This second formula is determined from the type of donation method selected in steps 4C-4E. For example if the user selected the standard donation rate then the second formula would be as follows:

(Charitable Donation)/(Number of Charities Selected)=Donation for Each Charity (2A)

For example, a user purchases $1000 worth of goods, and the first formula is applied at a default rate of 25% so that there is a $250 total Charitable Donation. If the user selects five charities, then $50 would go to each of the five charities.

However, if the user selected a weighted donation rate then the second formula would be:

(Charitable Donation)×(Allocation Rate For Charity(n))=Donation Amount For Charity(n) (2B)

Applying the facts as above, wherein there is a $250 total Charitable Donation, the user may for example select three charities with the first charity, Charity A, receiving 50% of the Charitable Donation, the second charity, Charity B, receiving 30% of the Charitable Donation, and the third charity, Charity C, receiving 20% of the Charitable Donation. In applying the above formula, Charity A receives $125, Charity B receives $75 while Charity C receives a $50 donation.

Finally if the user selected the capped donation rate then the second formula would be:

(Charitable Donation) (Cap Allocation System)=Donation Amount For Charity(n) (2C)

The cap allocation system is essentially a series of conditional statements so that if the first cap is met on the Charity that is selected to be first to receive donations, the remaining portion of the charitable donation is applied to the next conditional statement. This process is continued until the entire amount of charitable donation is exhausted. For example, a user may select three charities, Charity A, Charity B, and Charity C. Next, the user may select to have the first $50 to go to the Charity A with the next $100 being sent to Charity B with the remaining amount being sent to Charity C. Applying the facts as above, there is a Charitable Donation of $250. After applying these conditional statements, the first $50 of the $250 Charitable Donation is sent to Charity A, the next $100 of the remaining $200 in the Charitable Donation is sent to Charity B, while the remaining $100 in the Charitable Donation is sent to Charity C.

In these last two versions of the second formula, each charity must be analyzed individually because one of the selected charities may receive a donation amount from each user which is different than a donation amount sent to another charity.

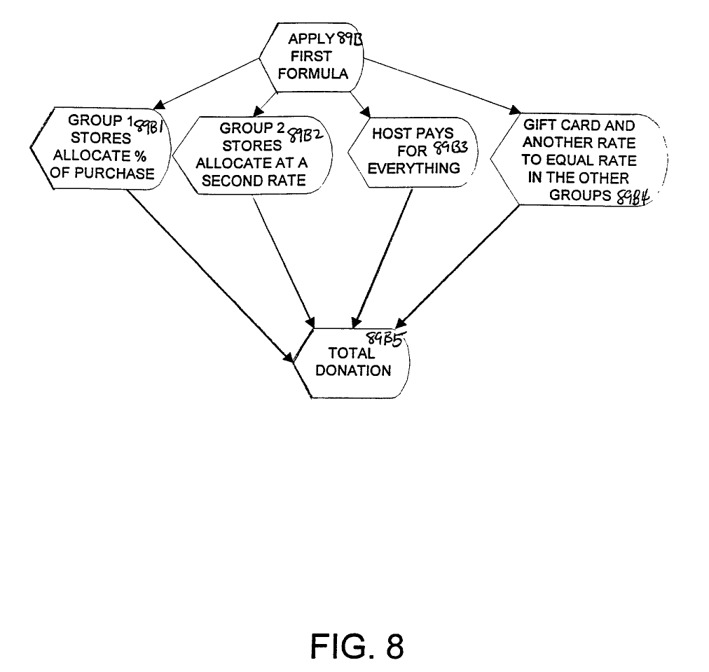

There is a second method to determine the charitable donation as shown in FIG. 8, provides flexibility in determining the first formula. For example after processing the information in step 87, and sorting this information in step 88, step 89 could include up to four different ways to determine the first formula. In step 89B1, all of the stores allocate a portion of the purchase at an equal donation rate. Thus, if the donation rate was set at 25% of each purchase, then all of the participating stores would contribute 25% of their purchases to the Charitable Donation. However, there could also be a second set of stores that donate at a different rate. In step 89B2, the donation rate could be set at a different level such as 10% of each purchase for a select series of stores.

Alternatively, the system may instead proceed to step 89B3 whereby the host pays for the entire Charitable Donation for all purchases. In this case, the host may be a landlord for all of the stores in a shopping mall. Finally, the system may proceed to step 89B4 whereby the donation amount is determined by adding up a partial contribution from steps 89B1, 89B2, or 89B3, and also a gift card which contributes to the Charitable Donation which is allocated in step 89C. Next, in step 89B5, the total donation is calculated from the donation in steps 89B1, 89B2, 89B3, and 89B4.

Next, in step 90, a series of tables or statements are created from these donation amounts and records determined in step 89. In step 91, these statements are sent out to the users such as purchasers, charities or store owners.

FIGS. 9A-9D show a series of tables that are stored in servers 110, 111, or 112 by the system host in step 90. These tables are then later printed out in the form of statements in step 91.

For example, FIG. 9A shows table 902 listing the unique charity shoppers by revenue. This list includes the following columns: name of a user or purchaser 904, address of user 906, the total amount of purchases in dollars 908, the total number of transactions 910 such as the number of shopping transactions by that user, a list of charities selected by that user 912 and the total donation donated by both the store or the host 914. This table is useful because it provides the system host with a listing of the shoppers making the largest amount of purchases.

FIG. 9B shows table 916 detailing the unique customer profile by card number. This table contains the following columns: name and address of the user 904, phone number of the user 918, card number 920 containing the user's identification number 350 located on the user's card, merchant number 922 which is associated with the identification number 352 given to the store owner, transaction date 924, charity 926 identification number which is associated with identification number 351, purchase amount 928, and charity name 912 and total donation 914. In this table, the purchases are tracked and then listed in this table so that each purchase can be tracked and then a charitable donation allocated from this purchase. This table is useful because it provides each shopper with an itemized list of purchases relating to this program.

FIG. 9C shows another table 940 showing the individual customer profile by card. This table contains the following columns: card number 920, purchase number 942, purchase amount 928, credit card number 944, charity number 926, Charitable Donation 930. Table 940 is created after a purchase has been made, wherein this information is sent to a server so that it is later sent on to be matched with the user's actual identification listed in tables 902 and 916. In addition, this table is useful because it provides a unique customer profile by card.

FIG. 9D shows table 950 which details the individual user's total purchase amount. This table includes the following columns: user card number 920, total purchase amount 952, charity number 926, Charitable Donation 930 which is the amount that each charity will receive and the total donation 914 which is the total donation amount of all charitable donations. This table is useful because it totals the spending for each user so that the system host can provide each user with a total amount as a summary statement.

FIGS. 10A-10D and 11A-11C represent a series of tables detailing reports for charities. Table 1002 is a listing of charity results by alphabetical sequence. This table includes a series of fields in the following columns: Charity name 912, total sales 908, store donation 1004 which is the portion of the donation contributed by the store, host donation 1006 which is the portion of the donation contributed by the host, and the total donation 914 which is the total of store donation 1004 and host donation 1006. This table is useful because it creates a list that can be reviewed and easily searched by the system host.

FIG. 10B shows table 1008 which is a listing of charity results by revenue including a series of fields in the following columns: charity id 926, total sales 908, store donation 1004, host donation 1006, and total donation 914. This table is useful because it provides a detailed report for the system host to determine which charity received the most donations.

FIG. 10C shows table 1010 which is a comparison of donations across the last few years. This table includes a series of fields in the following columns: charity name 926, latest year total donation 1012, percent change from previous year 1014, latest year −1 (last year) total donation 1016, latest year −2 (2 years ago) total donation 1018, latest year −3 (1997) 1020 and finally comments 1022. This table is useful because it allows the system host to provide a detailed report to each charity on its fundraising performance across a three-year period.

FIG. 10D shows table 1026 which details the donations to each charity by store. This table is for host in house use only. This table includes a series of fields having the following columns: store ID 1030 which is the identification number for the store 352, charity ID 1026, total sales 1008, store donation 1004, host donation 1006, and total donation 914. This table is useful because it allows the system host to provide charities with a report detailing the store location where the purchasers made their purchases to create a donation. In that way each charity would have a better idea about the purchasing profile of its users.

FIG. 11A shows table 1102 which is for a host to share with a store. This table includes a series of fields having the following columns: store name 1104, charity names 1106, total donation 914, store donation only 1004. This table can be used for the same purpose as table 1026 listed above.

FIG. 11B shows table 1110 which details the charity shopper list by charity. This table includes a series of fields having the following columns: charity name 1106, card number 920, name and address 917, donation amount 930. This table allows the system host to provide charities with a list of its donors.

FIG. 11C shows table 1120 which details the price range report for each purchase. This table includes a series of fields having the following columns: dollar range 1122, number of purchases 1124. This table is useful because it allows the system host to determine the range of purchases made by each purchaser.

FIGS. 12A-12C provide detailed reports for stores. For example, FIG. 12A shows table 1202 which details the store results for each store based upon purchases in that store. This table includes a series of fields having the following columns: merchant name 922, total sales 908, transactions 910, store donation 1004, host donation 1006, total donation 914. This table is useful because it allows the host to calculate for each store the results of the purchases in that store.

FIG. 12B shows table 1204 listing the store results by revenue. This table includes a series of fields having the following columns: merchant name 922, total sales 908, transactions 910, store donation 1004, host donation, 1006, total donation 914. This table is useful in that it allows the system host to rank the stores by their revenue generating potential.

FIG. 12C shows table 1206 listing the store detail report by alphabetical sequence. This table includes a series of fields having the following columns: merchant name 922, card number 920, name 904, address 906, transaction 910, date 924 and total donation 914. This table is useful in that it provides the system host with a detailed report on the store by an alphabetical sequence. In all of these reports, the users, including the purchasers, the charities and the stores can be tracked using either the actual names of the users or identification numbers associated with those users.

Essentially one benefit from using tracking numbers for the users, is that it allows the system to use more than one party to conduct this transaction without compromising privacy or security concerns of these users, charities and store owners. For example, if server 111 was included with these transactions as a credit card transaction server, information relating to a sale at a point of purchase would be coded using the user tracking number and the point of purchase tracking number so that server 111 would not have access to the users or the store owner's identity. This information could then be sent onto an additional third server 112 for decoding, and eventual processing on server 110, or straight on to server 110 for decoding and processing. At the decoding stage, the tracking numbers for the users, store owners, and charities are matched with the identities of these parties so that the system host will know where to send the charitable contributions and statements.

In applying program 1 and the steps outlined above, program 1 can transform a standard industry server into a server that performs a series of particular tasks. As shown in FIGS. 13A and 13B, second server 111 could reside on network 100 as a charge card transaction server, reading only the purchase information and then eventually forwarding this information to server 110. Second server 111 would contain a purchase information compiler 111A formed from the combination of software and hardware residing of server 111. This software and hardware includes a portion of program 1, coupled with processor 113′, mass storage 114′, and memory 116. Purchase information compiler 111A would receive coded data from remote computer 135 and input device 155 representing any of the input devices 131, 132, 133 and 134 shown in FIG. 1. Compiler 111A would organize this coded data so that it can be sent to another server for decoding. This purchase information is coded because it keeps the identity of the users such as the purchaser, the store owner and the charity secret via identification numbers rather than names and addresses. Thus, with this design, operators of second server 111 such as charge card companies would not have access to a user's personal information.

As shown in FIG. 13A this coded information in the form of compiled purchase information is sent to server 110 which includes an identification decoder 110A for decoding the compiled purchase information. This information is decoded by matching the identification numbers of the users with the identity of the users. The identity of the users is received by server 110 from remote computer 130, wherein users such as purchasers, charities and store owners sign up through remote computer 130 to enroll in the charitable giving program. Once this information has been decoded, a charitable donation calculator 110B applies the first formula shown above and outlined in steps 89B-89B5 to calculate the appropriate amount of a charitable donation from a purchase or a series of purchases made by an individual purchaser. Next, a charitable donation allocator 110C applies the second formula shown above and outlined in step 89C to allocate a charitable donation to each charity. A report generator 110C disposed within server 110 then creates statements as described in step 90, and distributes these statements as described in step 91.

In another embodiment of the invention, the identification decoder 110A could reside on a separate server 112 and would now be known as identification decoder 112A. In this case, separate server 112 would receive the compiled purchase information and then send it on to server 110 for further processing.

Accordingly, while several embodiments of the present invention have been shown and described, it is to be understood that many changes and modifications may be made thereunto without departing from the spirit and scope of the invention as defined in the appended claims.

What is claimed is:

1. A system for automatically processing and allocating charitable donations comprising:
a) at least one remote input device disposed at a point of purchase that receives a set of purchase information including a purchase identifier from at least one user;
b) a first server in communication with said at least one remote input device, said first server including a purchase information compiler that receives, sorts and stores said set of purchase information;
c) a second server in communication with said first server, said second server including:
i) a charitable donation calculator that determines an amount of a charitable donation based upon an amount of a purchase contained in said set of purchase information;
ii) a charitable donation allocator that allocates at least a portion of said charitable donation to at least one charity;
iii) an identification decoder that matches said purchase identifier with a name and a full identity of said purchaser with an identity of a point of purchase; and
iv) at least one report generator for generating a series of reports based upon a set of information created by said purchase information compiler, said charitable donation calculator, said charitable donation allocator, and said identification decoder.

2. The system as in claim 1, wherein said purchase identifier includes a set of coded information relating to a purchaser and a set of coded information relating to a point of purchase.

3. The system as in claim 2, further comprising an identification card that stores said set of coded information relating to said purchaser so that when said identification card is used in combination with said at least one remote input device, said at least one remote input device reads said set of coded purchaser information from said identification card.

4. The system as in claim 3, further comprising a credit card reader in communication with said server via said at least one communication path, said credit card reader for reading a set of information relating to a credit card and sending said set of credit card information to said at least one server.

5. The system as in claim 4, wherein said at least one remote input device reads at least one credit card so that said card reader can read a set of information relating to said at least one credit card and then send said set of credit card information to said first server.

6. The system as in claim 1, further comprising at least one remote computer connected to said at least one server via said at least one communication path, said at least one remote computer allowing said user to input a set of user identification information into said server.

7. The system as in claim 6, wherein said at least one remote computer allows said at least one charity to enter a set of charity identification information into said server.

8. The system as in claim 6, wherein said at least one remote computer allows said at least one point of purchase to enter a set of point of purchase identification information into said at least one server.

9. A system for automatically processing and allocating charitable donations comprising:
a) means for receiving purchase information;
b) at least one server comprising:
i) means for encoding said purchase information;
ii) means for decoding said purchase information;
iii) means for calculating a charitable donation from said purchase information;
iv) means for allocating said charitable donation to a series of different charities;
v) means for generating a series of reports based upon said decoded purchase information, said calculated charitable donation, and said allocated charitable donation; and
c) means for allowing said at least one server to communicate with said means for receiving purchase information.

10. The system as in claim 9, wherein said means for calculating a charitable donation includes means for determining whether a user or a host contributes to said charitable donation.

11. The system as in claim 9, wherein said means for allocating a charitable donation includes means for allocating a charitable donation evenly, means for allocating a charitable donation through a weighted average, and means for allocating a charitable donation through a cap and order style system.

12. The system as in claim 9, wherein said means for generating a series of reports includes means for calculating the total amount of charitable contributions generated at each point of purchase in a series of points of purchase.

13. A process for calculating a charitable donation from a purchase comprising the steps of:
receiving a set of information related to a purchase;
calculating a donation amount based upon an amount related to said purchase;
determining which of at least one charity taken from a set of charities will receive said donation amount; and
distributing said donation amount to said at least one charity.

14. The process as in claim 13, further comprising the step of dividing said donation amount into at least two amounts.

15. The process as in claim 14, further comprising the step of selecting at least one additional charity taken from said set of charities.

16. The process as in claim 15, further comprising the step of dividing said donation amount equally among said at least one charity and said at least one additional charity.

17. The process as in claim 15, further comprising the step of dividing said donation between said at least one charity and said at least one additional charity using a weighted average.

18. The process as in claim 15, further comprising the steps of determining a donation order and then dividing said donation amount up between said at least one charity and said at least one additional charity by setting a cap for each donation.

19. An article of manufacture comprising:
a) a computer usable medium having a machine readable program code means for means for receiving purchase information;
b) a machine readable program code means for encoding said purchase information;
c) a machine readable program code means for decoding said purchase information;
d) a machine readable program code means for calculating a charitable donation from said purchase information;
e) a machine readable program code means for allocating said charitable donation to a series of different charities;
f) a machine readable program code means for generating a series of reports based upon said decoded purchase information, said calculated charitable donation, and said allocated charitable donation.

20. A system for automatically processing and allocating charitable donations comprising:
a) at least one remote input device disposed at a point of purchase that receives a set of purchase information including a purchase identifier from at least one user;
b) a first server in communication with said at least one remote input device, said first server including a purchase information compiler that receives, sorts and stores said set of purchase information;
c) a second server in communication with said first server, said second server including an identification decoder that matches said purchase identifier with a name and a full identity of said purchaser and with an identity of a point of purchase;
d) a third server in communication with said second server and said first server said third server including:
i) a charitable donation calculator that determines an amount of a charitable donation based upon an amount of a purchase contained in said set of purchase information;
ii) a charitable donation allocator that allocates at least a portion of said charitable donation to at least one charity;
iii) at least one report generator for generating a series of reports based upon a set of information created by said purchase information compiler, said charitable donation calculator, said charitable donation allocator, and said identification decoder; and
e) a communication network for allowing said first server, said second server and said at least one remote input device to communicate with each other.
